(19) United States
(12) Patent Application Publication
(10) Pub. No.: US 2016/0044301 A1
(43) Pub. Date: Feb. 11, 2016

(54) 3D MODELING OF IMAGED OBJECTS USING CAMERA POSITION AND POSE TO OBTAIN ACCURACY WITH REDUCED PROCESSING REQUIREMENTS

(71) Applicants: Dejan JOVANOVICH, Austin, TX (US); Keith Beardmore, Santa Fe, NM (US); Kari Myllykoski, Austin, TX (US); Mark O. Freeman, Snohomish, WA (US)

(72) Inventors: Dejan JOVANOVICH, Austin, TX (US); Keith Beardmore, Santa Fe, NM (US); Kari Myllykoski, Austin, TX (US); Mark O. Freeman, Snohomish, WA (US)

(21) Appl. No.: 14/452,937

(22) Filed: Aug. 6, 2014

(51) Int. Cl. H04N 13/02; G01C 3/02; G06T 7/00

(52) U.S. Cl. CPC H04N 13/0282; H04N 13/0275; G06T 7/0044; G01C 3/02; G06T 2207/10028; G06T 2207/20068; G06T 2207/30244

(57) ABSTRACT

3D Modeling System and Apparatus for mobile devices with limited processing capability is disclosed. This invention uses the standard camera and computing resources available on consumer mobile devices such as smart phones. A light projector (e.g. laser line generator) is attached as an accessory to the mobile device or built as a part of the mobile device. Processing requirements are significantly reduced by including a known object or reference template in the scene to be captured which is used to determine the pose and position of the camera relative to the object or scene to be modeled. The position and pose of the camera and projector is facilitated by image distortions of known dimensions of the reference template or known object in a sequence of captured images. The distortions also facilitates the proper registration between all images in the sequence.

### RELATED APPLICATION

This application is a utility application claiming priority of U.S. provisional application(s) Ser. No 61/732,636 filed on 3 Dec. 2012; Ser. No. 61/862,803 filed 6 Aug. 2013; and Serial No. 61/903,177 filed 12 Nov. 2013 U.S. Utility applications Ser. No. 13/861,534 filed on 12 Apr. 2013; and Ser. No. 13/861,685 filed on 12 Apr. 2013; and Ser. No. 14/308,874 filed Jun. 19, 2014.

### TECHNICAL FIELD OF THE INVENTION

The present invention generally relates to optical systems, more specifically to electro-optical systems that are used to determine the camera position and pose relative to the photographed scene in order to extract correct dimensions of objects from photographic images.

### BACKGROUND OF THE INVENTION

The present invention relates generally to three-dimensional (“3D”) modeling and more specifically it relates to an image data capture and more particularly, to a combination of processing systems, including a digital imaging device, an active illumination source detectible by the digital imaging device, computer and software that generates virtual 3D model data sets for real world objects. It is commonly understood that cameras take two-dimensional (“2D”) pictures of the scene presented to them. The scene typically contains 3D objects in a 3D environment but much of the 3D structure, such as size and shape of the objects or distance between objects, is lost in the 2D photographic view. The photo does not provide a way to get a 3D model of the scene. There are methods requiring multiple cameras and sophisticated processing to build 3D models of a scene, but these are not suitable for consumer devices with highly limited processing power. This invention provides a way to obtain complete 3D information about the scene using a standard camera such as those found in mobile consumer devices and with simplified processing capabilities that are compatible with those devices.

Existing methods of 3D acquisition require specialized hardware and significant computing resources to sense and extract the 3D information. Examples include time-of-flight sensors and multiple-pattern structured light projectors.

There is a need for an improved optical system for generating 3D models of 3D objects using conventional consumer electronics.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates view of the 3D modeling system in use on a three dimensional scene with three dimensional objects;

FIG. 2 illustrates a camera view of the scene in FIG. 1;

FIG. 3 illustrates an embodiment of a reference template employed in the scene illustrated in FIG. 1 and FIG. 2;

FIG. 4 illustrates an embodiment of a reference template illumination pattern of known dimensions;

FIG. 5 illustrates alternative reference template patterns;

FIG. 6 illustrates a diffraction grating for an alternative to a physical reference template;

FIG. 7 illustrates alternative reference template illumination patterns;

FIG. 8 illustrates a ranging illumination pattern;

FIG. 9 illustrates an alternative ranging illumination pattern;

FIG. 10 illustrates hardware components of the 3D modeling system;

FIG. 11 illustrates a camera accessory mounted on a conventional camera phone;

FIG. 12 illustrates an alternative embodiment to the accessory of FIG. 11 with two image projectors;

FIG. 13 illustrates the undistorted pattern of FIG. 4;

FIG. 14 illustrates the distorted active illumination pattern of FIG. 4 for a particular camera pose and position;

FIG. 15 illustrates the distorted active illumination pattern of FIG. 4 for another camera pose and position;

FIG. 16 illustrates the pixel mapping of the distortion ranges of the pattern illustrated in FIG. 4 for a projected reference template;

FIG. 17 illustrates an embodiment of a passive reference template pattern;

FIG. 18 illustrates the same scene as illustrated in FIG. 1 with the camera and projector in a different pose and position (note the lowered laser line projection);

FIG. 19 is a simplified flowchart of the processing of multiple image frames into a 3D model;

FIG. 20 is a simplified flowchart of the processing of removing background data from the laser ranging lines using an on-off modulated laser projector synchronized to the video frame rate;

FIG. 21 is a simplified flowchart of the processing of removing background data from the laser ranging lines using a time sequenced, pose and position registered images;

FIG. 22 is an example of the output of the light pattern detection subsystem and the reference template recognition subsystem;

FIG. 23 is a simplified flowchart of the extraction of dimensional information from the 3D point cloud model of the image captured object;

FIG. 24 & FIG. 25 illustrate how the ranging laser triangulation portion of the surface point cloud 3D model is calculated;

FIG. 26 & FIG. 27 illustrate how the camera pose and position is calculated from the reference template distortion data; and

FIG. 28 illustrates a real world application where a dimensionally correct 3D model of a flight of stairs is created by capturing the 3D data using an embodiment of the system described herein.

### DETAILED DESCRIPTION OF THE INVENTION

Preferred embodiments of the present invention are illustrated in the FIGUREs, like numerals being used to refer to like and corresponding parts of the various drawings.

The present invention generally relates to an improved optical system for creating a virtual 3D mapping of the surface of three-dimensional (“3D”) objects employing an ordinary digital camera such as is common in mobile consumer devices such as cell phones, smart phones, tablets, laptops or any other portable device in combination with a consumer light projector engine (e.g. laser line generator) which projects a single simple light pattern, such as a single straight line.

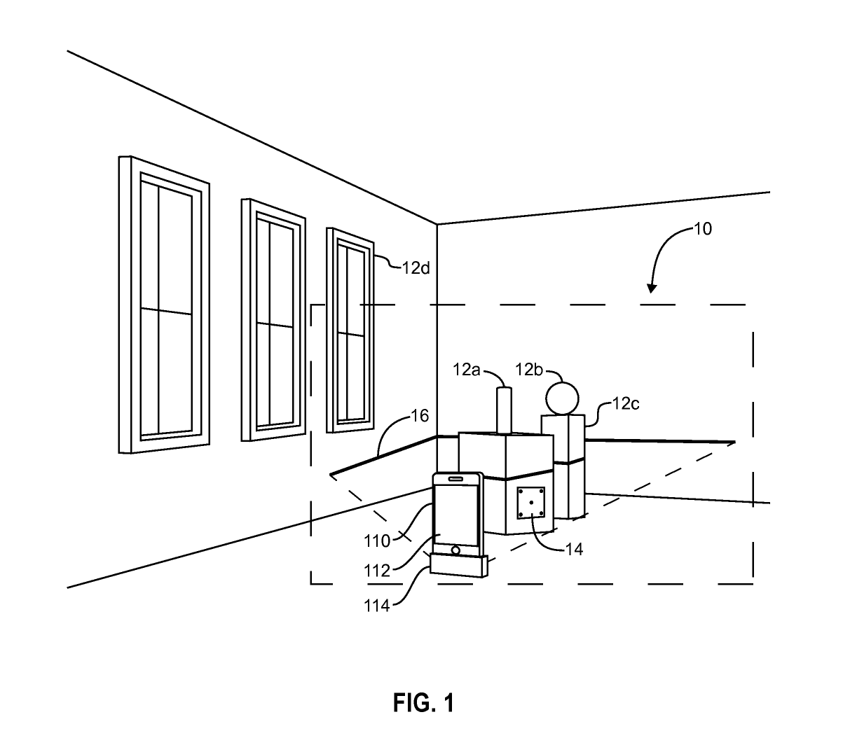

FIG. 1 illustrates an embodiment of such a 3D modeling system 110 in its operation environment 10 with an assortment of 3D objects such as cylindrical object 12a, a ball 12b on a pedestal 12c in a room 12d to be captured/modeled. A known reference object or template 14 with known dimensions is placed in the scene 10. As described further below, the position and pose of the camera 112 and projector 114 of the 3D modeling device 110 are calculated from distortions of the known relative dimensions of the reference template/object 14 in multiple images in a sequence of captured images. The relative registration between all images in the sequence is also determined from this captured image data of the reference template/known object 14. Surface point range data is extracted from the image using the camera pose and position and the projected pattern image 16 generated by the light pattern projector 114 incorporated in or attached to the consumer mobile camera computing device 112 as described in greater detail below.

The system also extracts dimensional information of the objects in the imaged scene and a 3D model of the scene from images of the scene taken from a sequence camera poses and positions about and around the objects of interest.

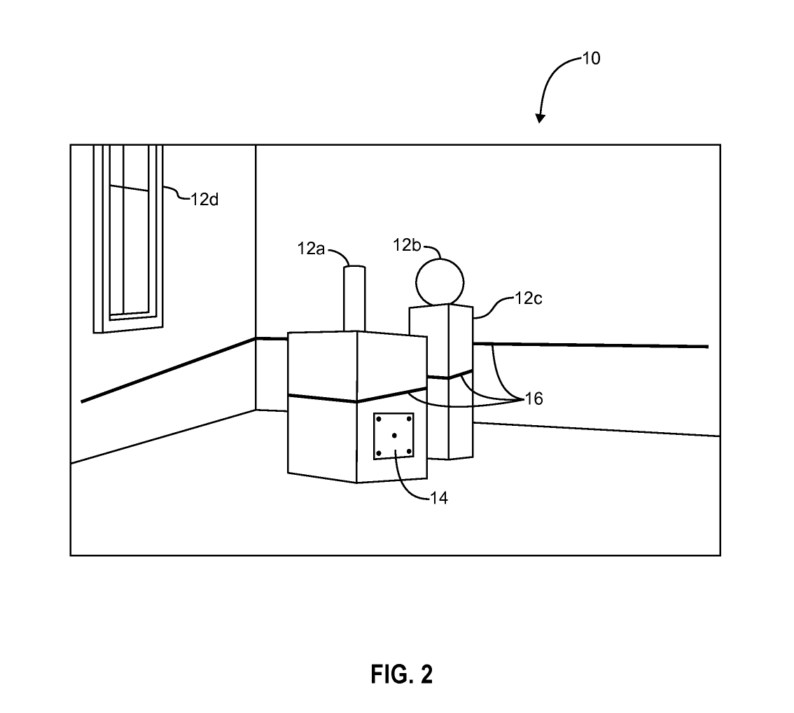

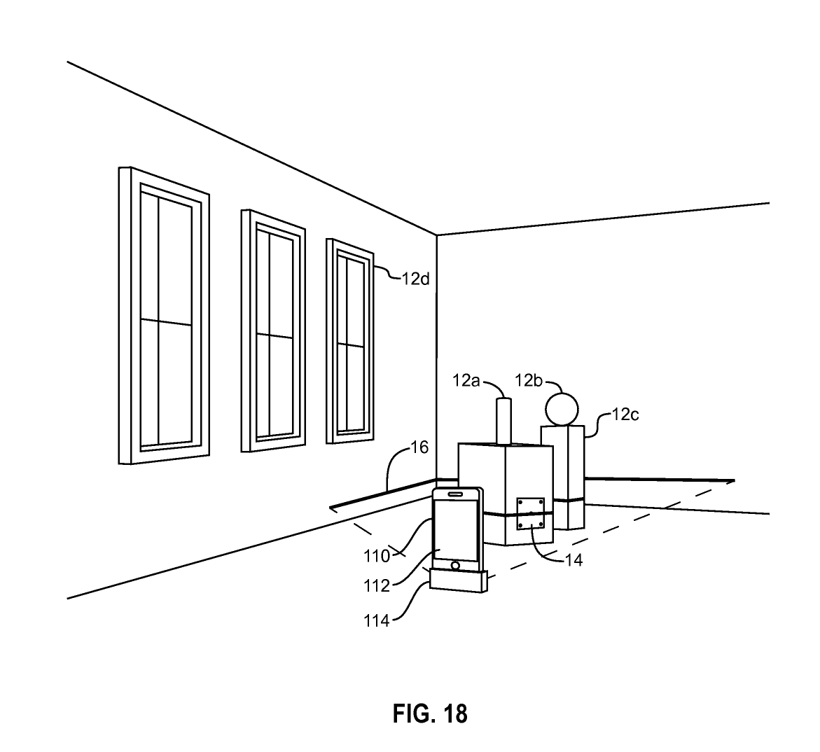

FIG. 2 illustrates the same scene as illustrated in FIG. 1 but from the perspective of the camera. FIG. 18 illustrates the same scene 10 with the camera 110 and projector 114 of the 3D modeler not shown. In order to get a 3D model of the objects, the camera pose and position is changed as the camera is moved around and about the object of interest capturing a sequence of images as the laser line 16 (projected light ranging pattern) is scanned over the various surfaces of the object of interest while maintaining at least one reference template 14 in the field of view of the camera 112.

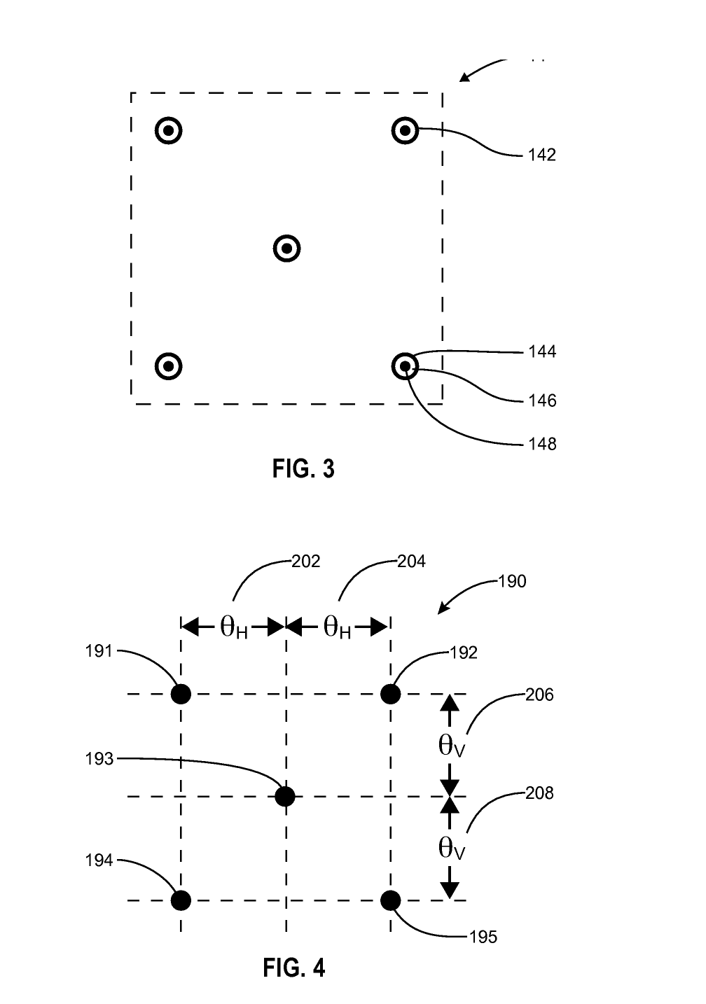

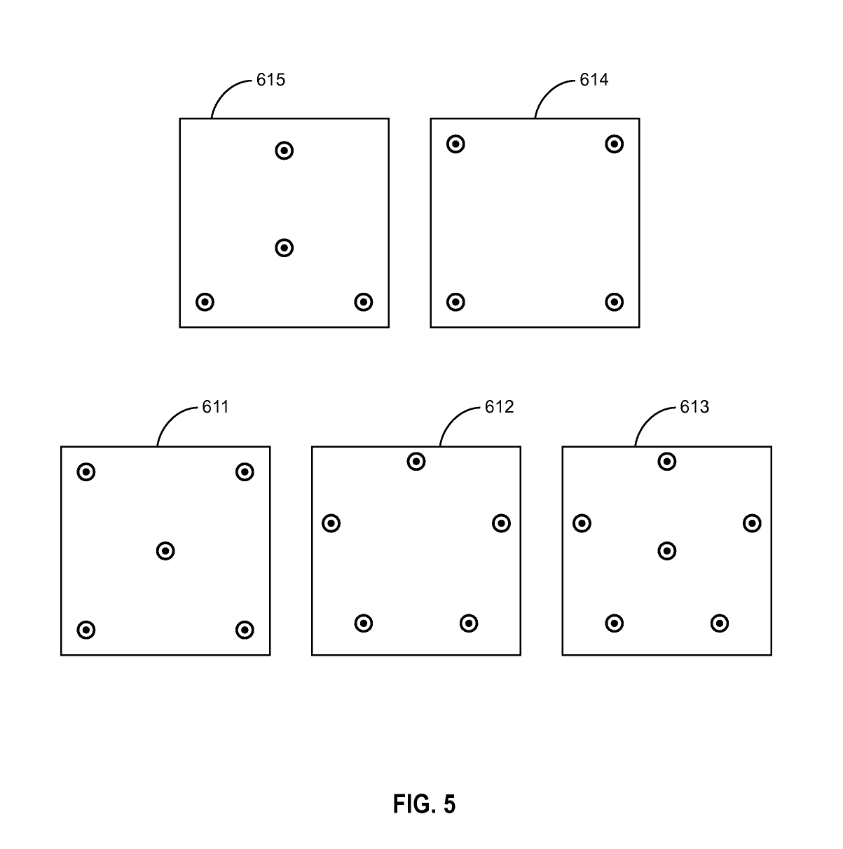

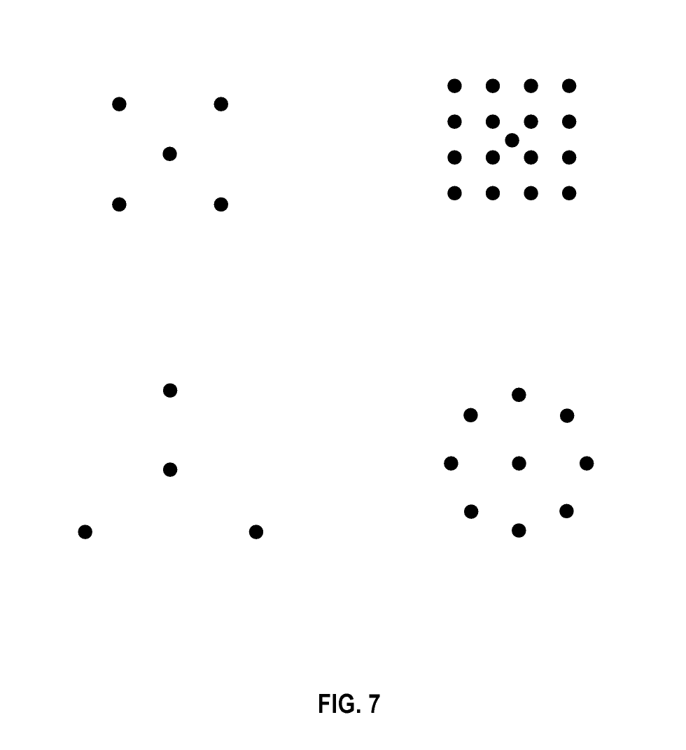

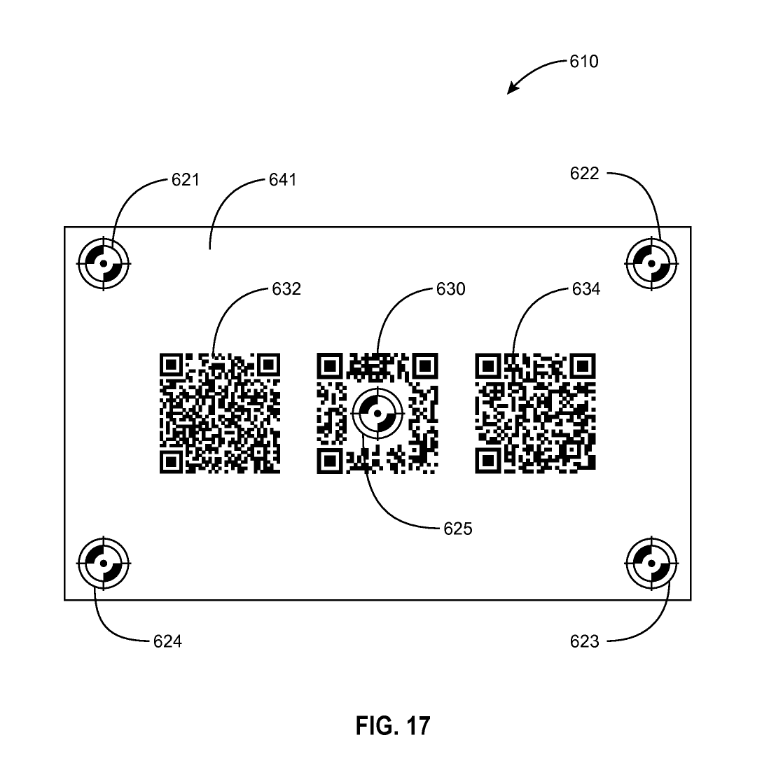

Various embodiments of the reference template or reference template pattern are illustrated in FIG. 3, FIG. 4 several in FIG. 5, several more in FIG. 7, and a another embodiment in FIG. 17. FIG. 3 illustrates one preferred embodiment of the known reference object/template 14. This embodiment employs a pattern of 5 points 142 in a configuration that closely resembles the dot pattern on a typical die in a pair of dice. It could be smaller than a die or larger depending on the geometries of the framing of the camera and the object. For normal consumer mobile device camera use, the applicants have used a template where the general scope of distances of the dots in the patter are approximately 4 inches apart in the x and y coordinate take up a good portion of a regular A4 or 8.5×11 sheet of paper.

As previously mentioned, FIG. 3 illustrates an embodiment of a known reference object or template. This pattern is used for determining the camera's position and pose relative to the object imaged such as the objects 12a, 12b, 12c, or 12d in FIG. 1. FIG. 4 illustrates the analogous reference template pattern as it would be using an active projected reference template rather than a passive fixed template. In this case, the angles between the reference template fiducials are known rather than the absolute distance between the fiducials as in the case of a passive reference template. The pattern generated is the five points 191, 192, 193, 194, 195 illustrated in FIG. 4. The ratios and distances will vary. If the size of the pattern changes based on distance between the object andithe cra, one embodiment, the design described above: the θᵥ 206 and 208 and θ_{H} 202 and 204 values are 15° In another design these distances were 11°. As described below, the camera pose and position can be determined/calculated from variations in these distances and the ratios between the distances.

Note that in some embodiments, the pattern is of a series of simple dots. In others, it is a series of more compliacted patterns such as the targets in FIG. 3 with a bulls eye 148 an inner ring 146 and outer ring 144 in alternating or offsetting colors or shading. An even-more-complicated pattern is illustrated in FIG. 17. Applicants have found the dots 621 illustrated in FIG. 17 to be preferable as easier to locate programmatically. In any case, the objective of the pattern is to make the point pattern easier to identify and pinpoint more accurately in a image taken by the camera sensor.

FIG. 17 illustrates an embodiment of the image-based dimensioning method and system employing a passive reference template placed within the scene containing an object to be modeled. The embodiment of the passive reference template 610 illustrated in FIG. 17 is a pattern printed on a label 641 which is attached proximate to the object to be modeled (not shown). The pattern is comprised of the five point patterns 621, 622, 623, 624 and 625. Other point patterns are possible and other configurations of point are also possible.

FIG. 17 also illustrates an embodiment with other parts—the three UID code patterns 630, 632, and 634 (or similar binary code patterns). In this embodiment, the left-most UID 632 illustrates a UID code pattern whereby an appropriate decoder will direct the user's electronic device to a location where the image-based measuring system software can be downloaded to the user's electronic device. The UID 634 on the right-most side, when decoded by the user, will notify the user of special promotions for a sponsor or the store, possibly related to the object on which the reference template is affixed or placed on the object to be imaged, characterized and ultimately dimensioned. The center UID 630 in the embodiment shown has a reference template fiducial 625 incorporated into the UID code image 630.

In the embodiment shown, the UID may provide the user and camera other information about the image or related images. For example, the UID may provide the user or camera with information about the product, such as pantone colors, weight, manufacturer, model number variations available etc.

In alternative embodiments, rather than a stationary reference template in the scene proximate to the object to be modeled, there may be an actively projected pattern which is stationary. In still other embodiments, the projected image might change. In any case, what is important to this invention is that from the appearance of the stationary or moving pattern projections, the cameras pose and position is determined.

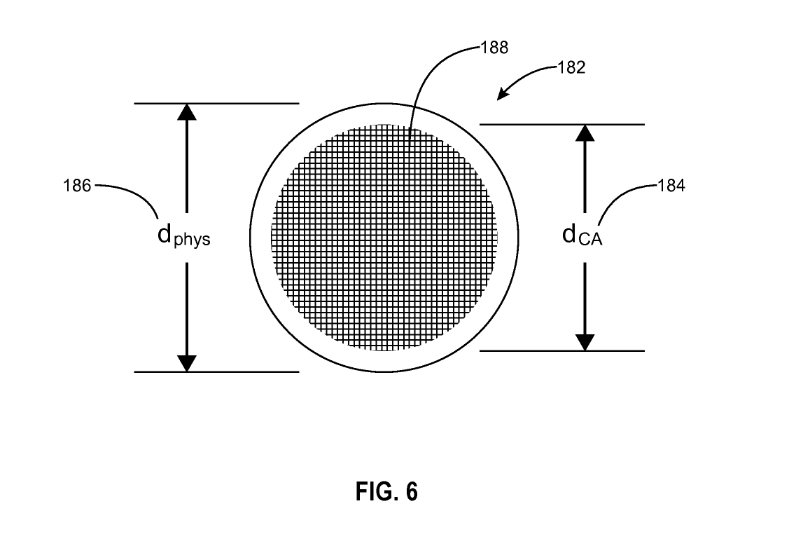

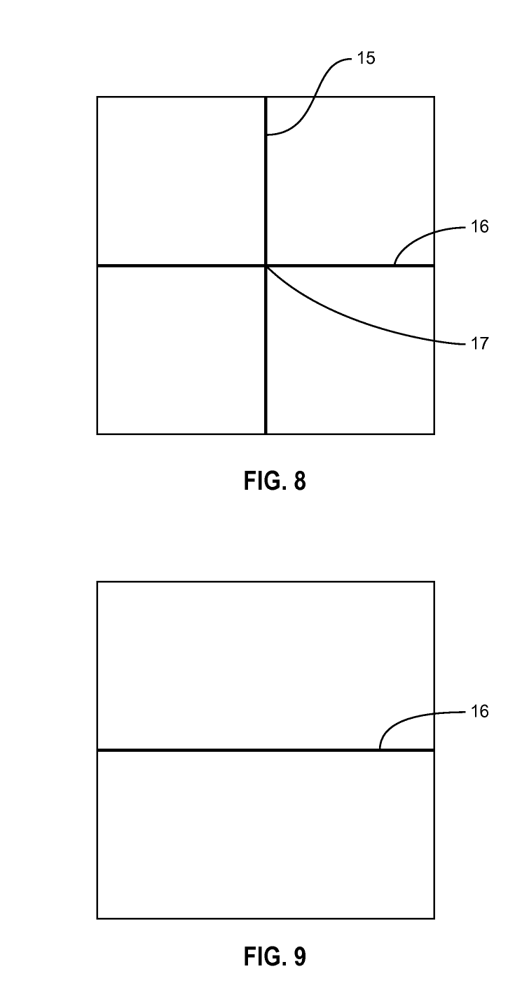

FIG. 6 illustrates a in greater detail the creation of a projected reference template patterns. In a typical embodiment of the systems described herein, the pattern is generated by placing a diffraction grating in front of a laser diode. FIG. 6 illustrates a Diffractive Optical Element, (DOE) for generating the desired pattern. In an embodiment of the active reference template system 118, the DOE 180 has an active diffraction area 188 diameter of about 5 mm, a physical size of about 7 mm. And a thickness between 0.5 and 1 mm. The DOE is placed before a red laser diode with a nominal wavelength of 635 nm with an expected range of 630-640 nm. The pattern generated could be one of the reference template patterns discussed above for determining the pose and position of the camera or it could be one of the patterns described below and illustrated in FIG. 8 and/or FIG. 9 for creating the laser ranging pattern used for surface modeling of the object.

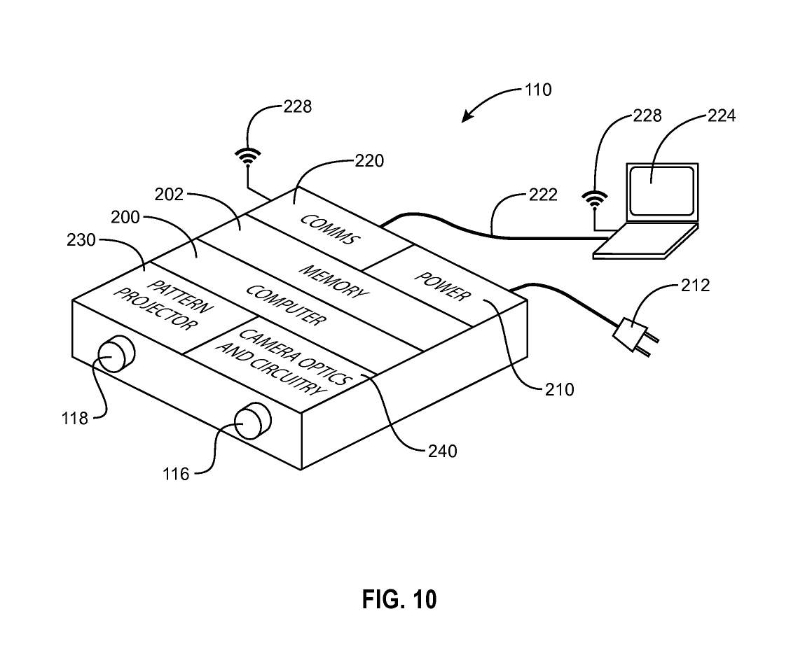

FIG. 10 illustrates primary major hardware components of the 3D surface modeler 110. For simplicity the figure does not include much of the supporting infrastructure for these components. For the camera an ordinary digital camera 240 such as is common in mobile consumer devices such as cell phones, smart phones, tablets, laptops or any other portable device in combination with a consumer light projector engine 230 (e.g. laser line generator) which projects a single simple light pattern, such as a single straight line. The many projection patterns are possible, for simplicity of computation, the applicants have found that the two preferred patterns are either a straight line 16 (as illustrated in FIG. 1, FIG. 2, FIG. 9 and FIG. 18) which may be horizontal or vertical, or a perpendicular cross-hair 17 pattern with two lines, 15 and 16, oriented at 90 degrees to each other (as illus).

A known reference object or template as described above with known dimensions is placed in the scene to be captured/modeled as described above. The position and pose of the camera and projector are calculated from distortions of the known dimensions of the reference template/object in multiple images in a sequence of captured images. The pose of the camera is determined by mapping the distorted positions of the reference template fiducials in the camera image into the known undistorted positions of the fiducials in the actual reference template. The relative registration between all images in the sequence is also determined from this captured image data of the reference template/known object.

As stated above, Cameras take 2D pictures of the scene presented to them. The scene contains 3D objects in a 3D environment but much of the 3D structure, such as size and shape of the objects or distance between objects, is lost in the 2D photographic view. The photo does not provide a way to get a complete 3D model of the scene. There are prior art methods requiring multiple cameras and sophisticated processing to build 3D models of a scene, but these are not suitable for consumer devices with highly limited processing power. This invention provides a way to obtain complete 3D information about the scene using a standard camera such as those found in mobile consumer devices and with simplified processing requirements that are compatible with those devices. The invention claimed here solves this problem.

This 3D modeler 110 utilize a known reference object with certain properties which is added to the scene prior to photographing. With this, simple processing can be applied to the series of images to build a complete 3D model of the scene. Or, if just particular information is needed, such as the dimensions or surface area of some object in the scene, this invention provides a method to obtain this information with even further reduced processing requirements.

The combination and processing architecture differs from what currently exists. The processing flows of the architecture fit the processing power of today's consumer electronic user's devices employing geometrical measurements in an environment that has low processing power (like a mobile consumer device) while at the same time allowing for a complete 3D model where processing power is not limited.

With their requirements for specialized hardware and high computing power, existing 3D acquisition systems are not easily adaptable to today's mobile consumer devices.

As described below, the described 3D modeler uses the standard camera 240 and computing resources (computer with processor 200, memory 202, power typically including a battery and means 212 for connecting to a power source 210 and some sort of communications 222, 220, 228, 222 for connecting to a computer 224 or wireless or wired network) typically available on consumer mobile devices such as smart phones. A light projector 230 (e.g. laser line generator) is attached as an accessory to the mobile device. Processing requirements are significantly reduced by including a known object or reference template in the scene to be captured. The use of the known object in each image in the sequence of captured images allows for quick position and pose of the camera and light projector, as well as providing the proper registration between all images in the sequence.

Also, it can produce 3D models, physical representations of the 3D object or scene, including machine parts, artistic sculptures, toys, 3D memos of a configuration and with CNC and 3D printing capabilities added, can manufacture 3D copies of many 3D objects (objects where all of the objects characteristics can be determined from its camera visible surfaces).

The camera 240 is optical data capture device, with the output being preferably having multiple color fields in a pattern or array, and is commonly known as a digital camera. The camera function is to capture the color image data within a scene, including the active illumination data. In other embodiments a black and white camera would work, almost as well, as well, or in some cases better than a color camera. In some embodiments, it may be desirable to employ an optical or digital filter (not shown) on the camera that enhances the image projected by the active illumination device for the optical data capture device.

The camera 240 is preferably a digital device that directly records and stores photographic images in digital form. Capture is usually accomplished by use of camera optics (not shown) which capture incoming light and a photosensor (not shown), which transforms the light intensity and frequency into colors. The photosensors are typically constructed in an array, that allows for multiple individual pixels to be generated, with each pixel having a unique area of light capture. The data from the multiple array of photosensors is then stored as an image. These stored images can be uploaded to a computer immediately, stored in the camera, or stored in a memory module.

The camera may be a digital camera, that stores images to memory, that transmits images, or otherwise makes image data available to a computing device. In some embodiments, the camera shares a housing with the computing device. In some embodiments, the camera includes a computer that performs preprocessing of data to generate and imbed information about the image that can later be used by the onboard computer and/or an external computer to which the image data is transmitted or otherwise made available.

The projector 314 may be an active illumination device in the one several embodiments is an optical radiation emission device. The emitted radiation shall have some form of beam focusing to enable precision beam emission—such as light beams generated by a laser. The function is to emit a beam, or series of beams at a specific color and angle relative to the camera element. The active illumination has fixed geometric properties relative to the field of view of the camera.

However, in other embodiments, the active illumination can be any source that can generates a beam, or series of beams that can be captured with the camera. Provided that the source can produce a fixed illumination pattern, that once manufactured, installed and calibrated does not alter, move, or change geometry in any way. The fixed pattern of the illumination may be a random or fixed geometric pattern that is of known and predefined structure. The illumination pattern does not need to be visible to the naked eye provided that it can be captured by the camera for the software to detect its location in the image as further described below.

The illumination pattern generated by the active illumination device 230 has been previously discussed and the preferred embodiments illustrated in FIG. 8 or FIG. 9.

The illumination source 118 may utilize a lens system to allow for precision beam focus and guidance, a diffraction grating, beam splitter, or some other beam separation tool, for generation of multi path beams. A laser is a device that emits light (electromagnetic radiation) through a process of optical amplification based on the stimulated emission of photons. The emitted laser light is notable for its high degree of spatial and temporal coherence, unattainable using other technologies. A focused LED, halogen, or other radiation source may be utilized as the active illumination source.

The camera 240 may also include cameras with additional functionality. For example, the ability to refocus the image using post-processing, or the ability to capture images in other parts of the spectrum (e.g. infra-red) in addition to its basic visible light functionality.

Light pattern projector 230. One embodiment of this invention uses a visible laser similar to those used in laser pointers followed by an optical element that spreads the laser light into the desired pattern. The laser wavelength should be in the spectrum that can be detected by the standard digital camera 240. If the camera used in conjunction with the light pattern projector is able to detect light outside the visible spectrum, then the light pattern projector can operate in any wavelength of light that the camera is able to detect. However, it is still preferable for the user to be able to see the laser pattern on the object and not have to look at the camera display to see the surfaces that the laser is scanning The light-spreading element could be a DOE (diffractive optical element) or any other type of optical element such as refractive or reflective that produces the desired pattern. The desired pattern in the first embodiment is a single line of laser light. As previously described, in an alternative embodiment, the pattern is preferably a line or a pair of crossing lines; however other embodiments may use other patterns. Additionally it is not strictly necessary for the projector to use a laser with a diffraction grating. Any light projector technology could be used including incandescent, LED, arc lamp, etc, which can be used in a light engine that emulates the desired laser light pattern and is detectable by the camera sensor.

In the embodiment illustrated in FIG. 1, the known reference object or template is physically placed in the scene. There is great flexibility on the design of this reference template. It should be largely a 2D pattern, although 3D reference objects/templates are also acceptable. In one embodiment of this invention, a pattern of five bulls-eyes is used arranged as one bulls-eye at each corner of a square and the fifth bulls-eye at the center of the square. The essential requirement is that the 3D sensing system has knowledge of the exact geometry of the reference object. In processing, The system will recognize and identify key features (fiducials) of the reference object in each image within the sequence of captured images. Therefore, it is advantageous that the reference object be chosen for providing speed and ease of recognition. In another embodiment, the physical reference template may be composed of a pattern of LEDs (light-emitting diodes) or any other type of light source to make the key features of the reference template more easily recognized in low ambient light situations. The light-emitting reference template may also enable the use of shorter exposure times by the camera—thereby making the light-emitting reference template and projected light pattern easier to distinguish from the comparatively dimmer background. For ease of distinguishing the light emitting reference template from the projected light pattern, different wavelengths or colors may be chosen for the light-emitting reference template than those used in the light pattern projector.

FIG. 12 illustrates another embodiment of this invention which uses first and second light-emitting projectors 118 and 318 in this case the second projector projects the reference template.

In an alternative embodiment a single light pattern projector will be used to serve both the template function and pattern function. In further embodiments the single projector will flash between a ranging pattern and a reference template from which the pose and position and the surface ranging can be gathered as discussed below.

Data processing system 200, 202—This is a computing and processing device, most commonly the computing processor associated with a mobile consumer device. A series of processing steps are implemented in software to assemble the 3D model from the image sequence using the detected light patterns and reference template key features (fiducials).

FIG. 10 illustrates the components in a single housing. FIG. 1 and FIG. 11 and FIG. 12 illustrate alternative relationships between the hardware components. In the later embodiments, the light pattern projector is attached to the device that houses the digital camera and the data processing system , which also contains the light pattern detection system and the reference template recognition system which would typically be manifest as software applications saved in memory.

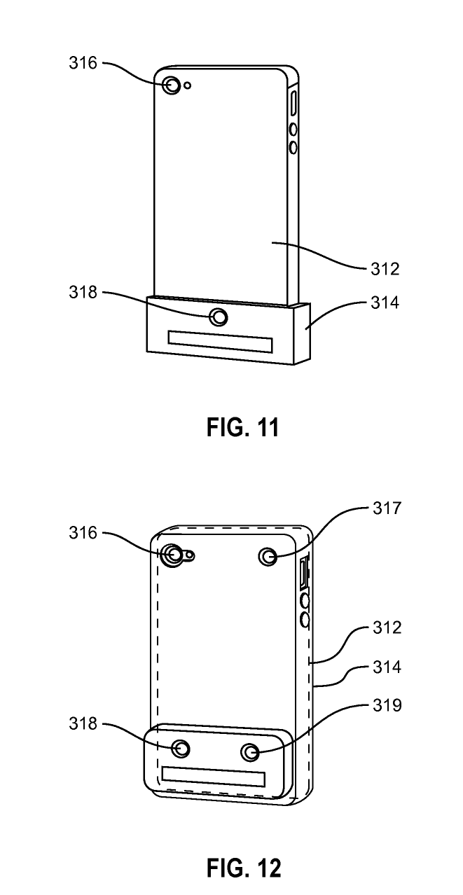

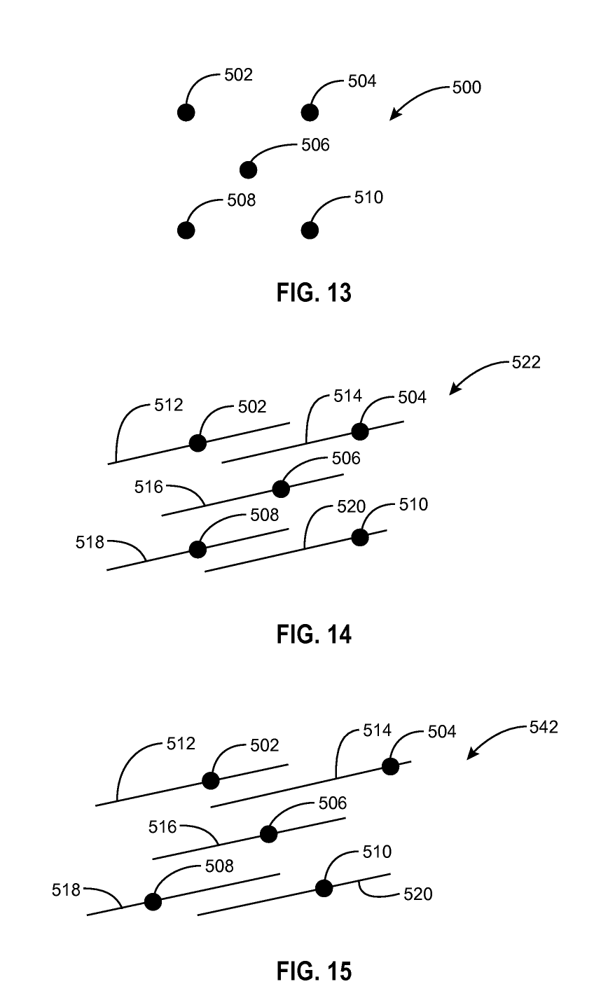

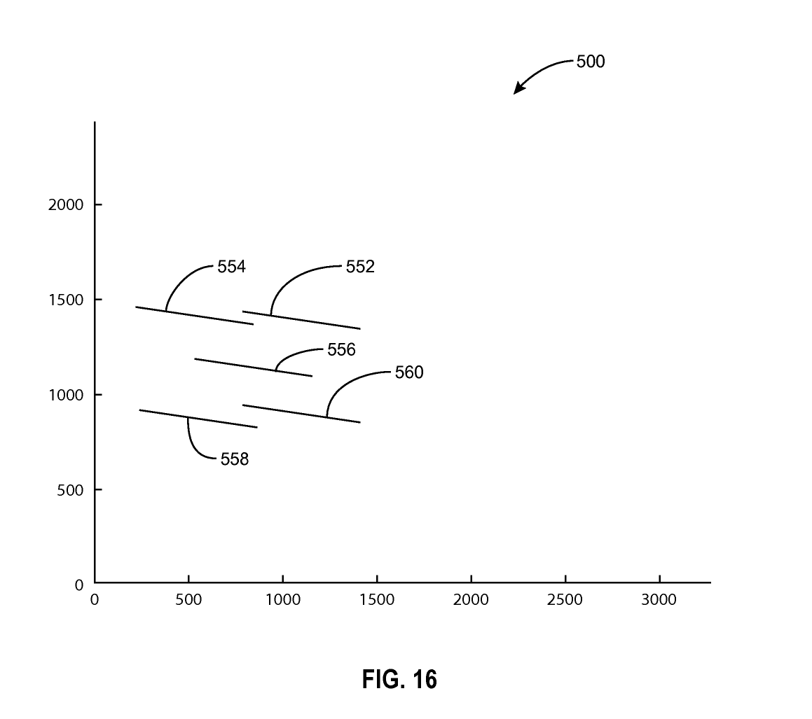

FIG. 11 shows the ranging projector 318 on an accessory 314 mounted to a mobile device 312 with a digital camera 316. FIG. 12 illustrates an embodiment that employs multiple cameras 316 and 317 and multiple projectors 318 and 319. In the embodiment shown some of this functionality is incorporated by accessory 314 which is a case for the mobile device 312.

In the embodiment shown, all of the processing is handled by the CPU (not shown) in the on-board computer 200. However in other embodiments the processing tasks may be partially or totally performed by firmware programmed processors. In other embodiments, the onboard processors may perform some tasks and outside processors may perform other tasks. For example, the onboard processors may identify the locations of illumination pattern in the picture. In other embodiments the collected data may be transmitted to another computer(s)or data processor(s) for processing.

Calibration System. This is an item which is used to provide a sensor system with ground truth information. It provides the correct relationship between the position on the camera's image sensor array of the projected light from the light ranging pattern projector and the range of the object point that is illuminated by the projected light. Integration and processing of calibration data and operation data forms corrected output data.

One embodiment of a suitable calibration system employs a specific physical item (Image board) that is of a predetermined size, and shape, which has a specifically patterned or textured surface, and known geometric properties. The Light Ranging Pattern Projector emits radiation in a known pattern with fixed geometric properties, upon the Image Board or upon a scene that contains the Image Board. In conjunction with information provided by an optional Distance Tool, with multiple pose and distance configurations, a Calibration map is processed and defined for the imaging system.

The calibration board may be a flat surface containing a superimposed image, a complex manifold surface, containing a superimposed image, an image that is displayed upon via a computer monitor, television, or other image projection device or a physical object that has a pattern of features or physical attributes with known geometric properties. The calibration board may be any item that has unique geometry or textured surface that has a matching digital model.

In another embodiment, only the Distance Tool is used. The camera and active illumination system is positioned perpendicular to the plane surface to be measured, or in other words, it is positioned to directly photograph an orthographic image. The Distance Tool is then used to provide the ground truth range to the surface. Data is taken in this manner for multiple distances from the surface and a Calibration Map is compiled.

Connections of Main Elements and Sub-Elements of Invention. In the image capture system, the Camera(s) must be mechanically linked to the Active Illumination device(s). In the embodiment 110 illustrated in FIG. 1 the mechanical linkage is based on both the camera 112 and active illumination device 114 being in physically attached to each other. In addition to being mechanically linked, it is preferable though not essential that the Camera and Active Illumination devices are Electrically linked.

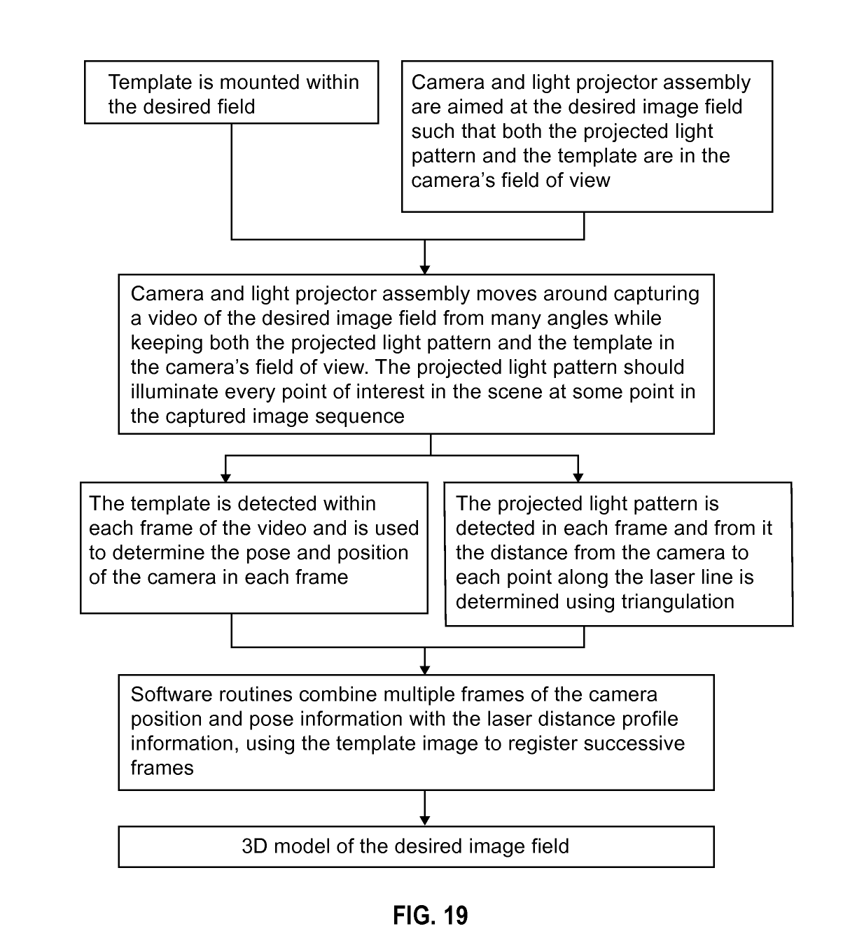

How the Invention Works. FIG. 18 provides a review of the forgoing description of the hardware for a discussion of how the hardware is employed to generate a 3D surface model of an object. The drawing is similar to FIG. 1 but shows a different pose and position of the camera (more angled down). The operation of the invention is diagrammed in the flow chart included as FIG. 19 which provides a simplified flow diagram for processing the multiple image frames into a single 3D model.

At least one reference template is placed in the scene keeping in mind that at least one reference template needs to be in view in every image for the image to provide useful information for the 3D Model. A standard digital camera such as the camera in a smart phone is used together with an auxiliary light pattern projector affixed to the camera to capture a stream of images that will be processed into a 3D model of the scene.

A known pattern is projected onto the scene by the light projector and the attached camera captures a sequence of images or stream of video as the camera/projector assembly is moved around. Each image in the sequence contains the reference template, projected pattern, and the object or scene of interest from a series of different viewpoints. In a first embodiment, the reference object is separate from the projected light pattern. In a second embodiment, the projected light pattern serves as the reference template and no further reference template is needed.

The reference template is used to establish a common and known reference for all views taken of the unknown scene or object. The pose and position of the camera and light pattern projector are determined with minimal processing from the view of the reference template in each image frame. The way the algorithm works is that the key features (fiducials) in the reference template produce image/world correspondences which allows a closed form solution of the homography (plane->plane perspective transformation) using the DLT algorithm (direct linear transform). For the camera pose, an algorithm is used to obtain the camera-target translation (pose) vector and a rotation matrix which determines the pose vector between the camera center and a reference fiducial mark. Having this pose vector in every image frame is key for assembling the 3D model.

In a first embodiment, the projected light pattern processing uses standard triangulation at each point in the detected light pattern on the camera sensor to determine the distance (depth) of that point from the camera center (after calibration) which gives the z distance from the camera center. The camera parameters are then used to calculate x- and y-components which creates a full vector from the camera to each detected laser point in the pattern.

To complete the 3D model in the first embodiment, we take the vector from each camera center to each projected light point in the scene and subtract off the pose vector from the camera center to the reference fiducial. This keeps the relative 3D position vector produced during each frame aligned to all others.

In a second embodiment, the projected light pattern serves as the reference template. The camera and attached light pattern projector moves around the scene capturing a sequence of images containing the projected reference template and the scene of interest. This embodiment uses a scale defining method based on the projected reference template in combination with real time structure from motion (RTSLM) or synchronized localization and mapping (SLAM) or similar 3D structure from motion (SFM) approach to define scale in a dense 3D image. As before, the pose and position of the camera is determined with minimal processing from the view of the reference template in each image frame. This enables the detailed measurement across the entire 3D model as calibrated from the scale defining method.

In a third embodiment, a physical reference template is placed into the scene as in the first embodiment, and there is no projected light pattern. The camera moves around the scene capturing a sequence of images containing the reference template and the scene of interest. The 3D model is created using in the same basic manner as the second embodiment, namely, real time structure from motion (RTSLM) or synchronized localization and mapping (SLAM) or similar 3D structure from motion (SFM) approach to define scale in a dense 3D image. As before, the pose and position of the camera is determined with minimal processing from the view of the reference template in each image frame.

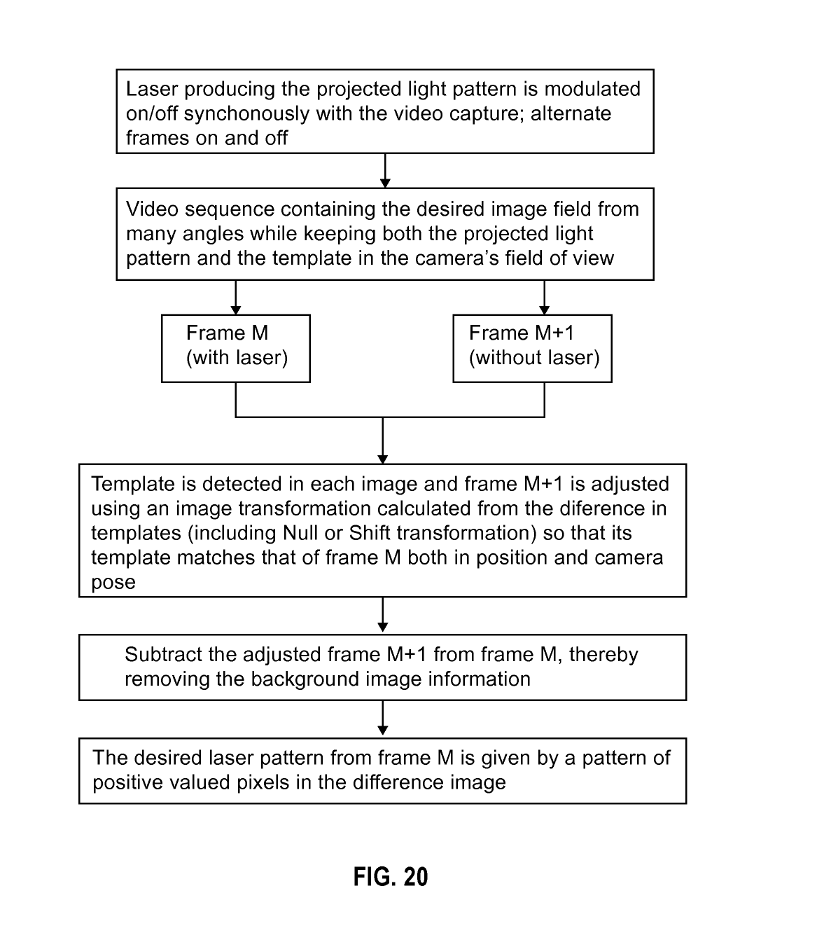

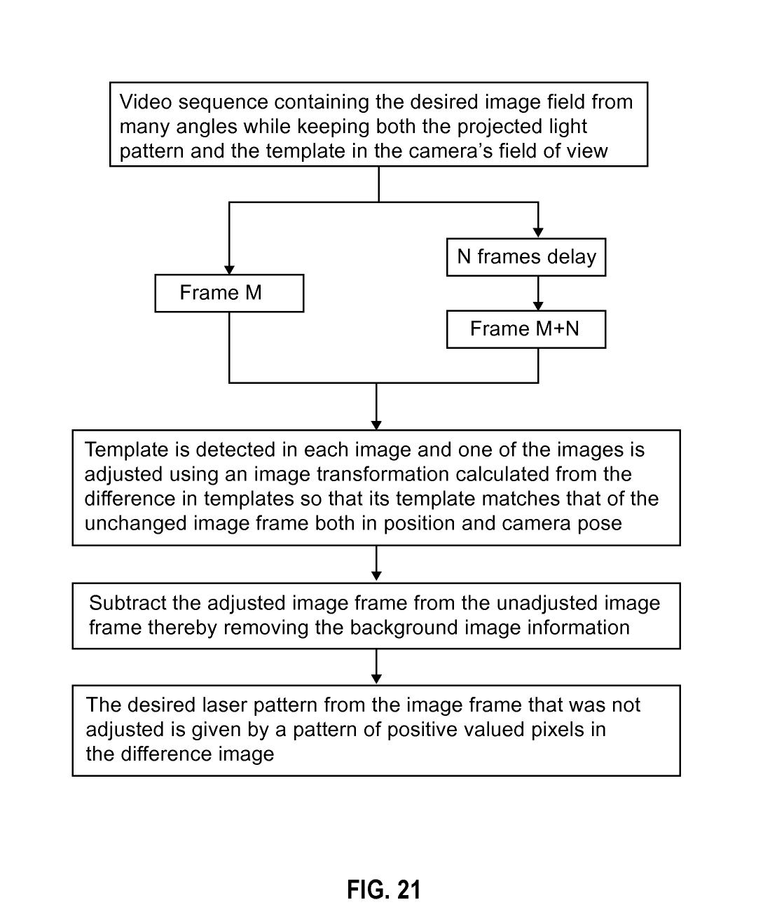

The light pattern detection subsystem can often be as simple as applying a threshold to the sequence of images to expose the brighter projected light pattern from the ambient background. FIG. 20 and FIG. 21 show two methods associated with this invention for detecting the projected light pattern when the ambient illumination is bright enough that simple image thresholding is insufficient to reliably detect the projected pattern.

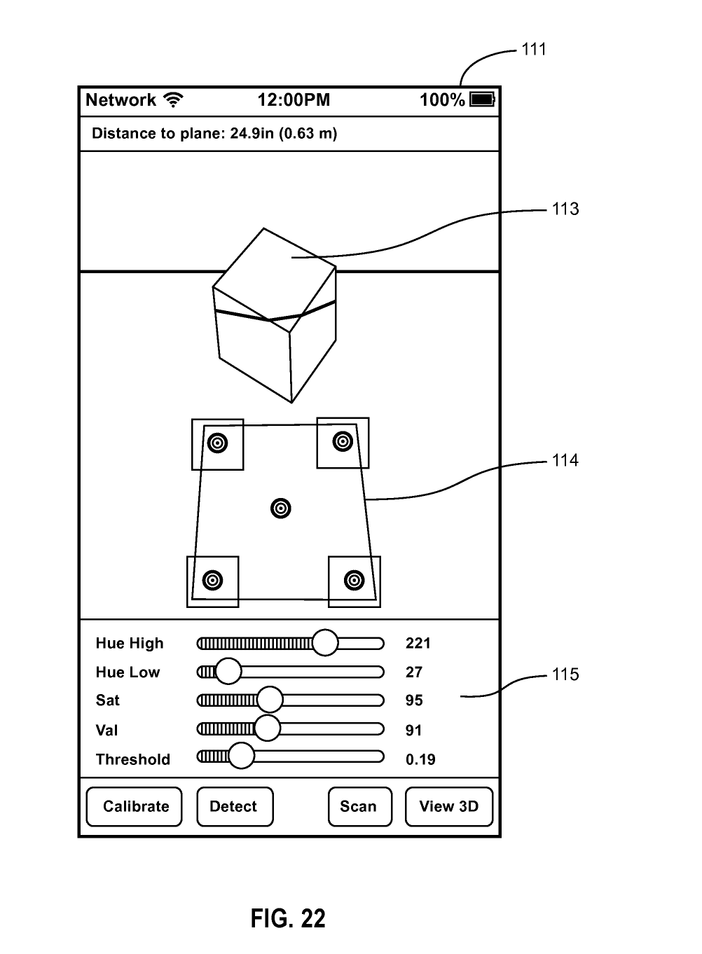

FIG. 22 shows an example of the display output 111 of the light pattern detection subsystem and the reference template recognition subsystem. Note this image shows the object modeled 113 the reference template 114 and the image control parameters 115.

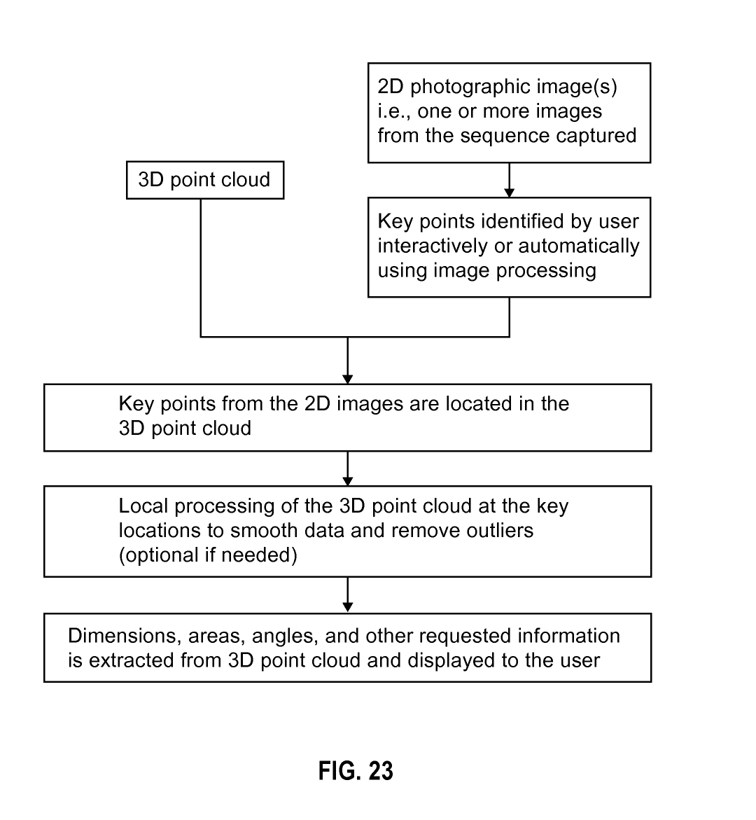

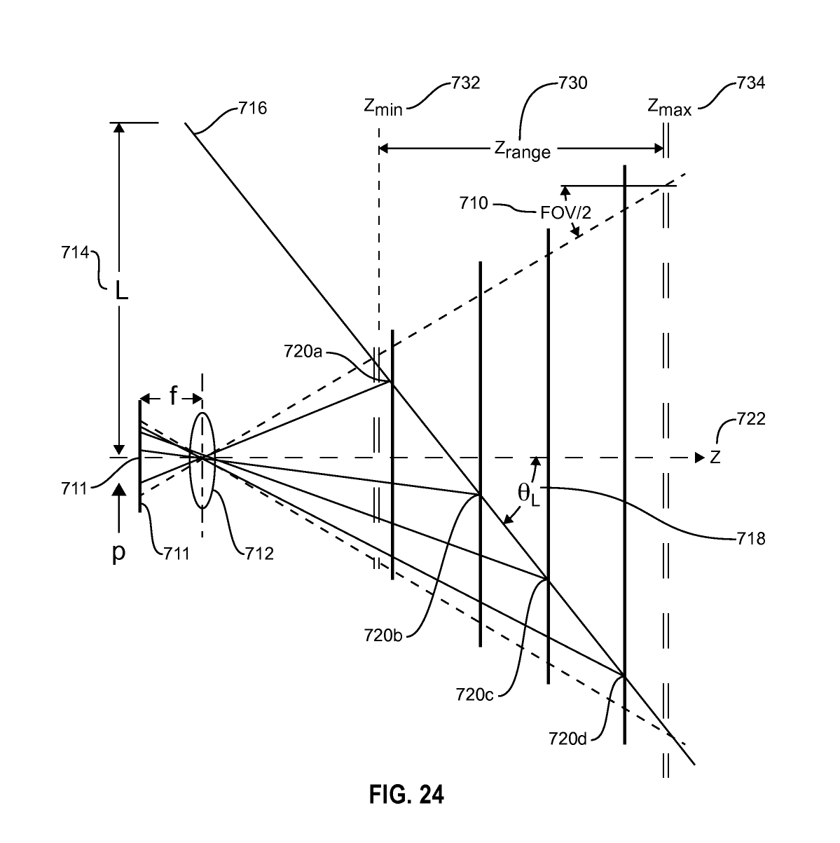

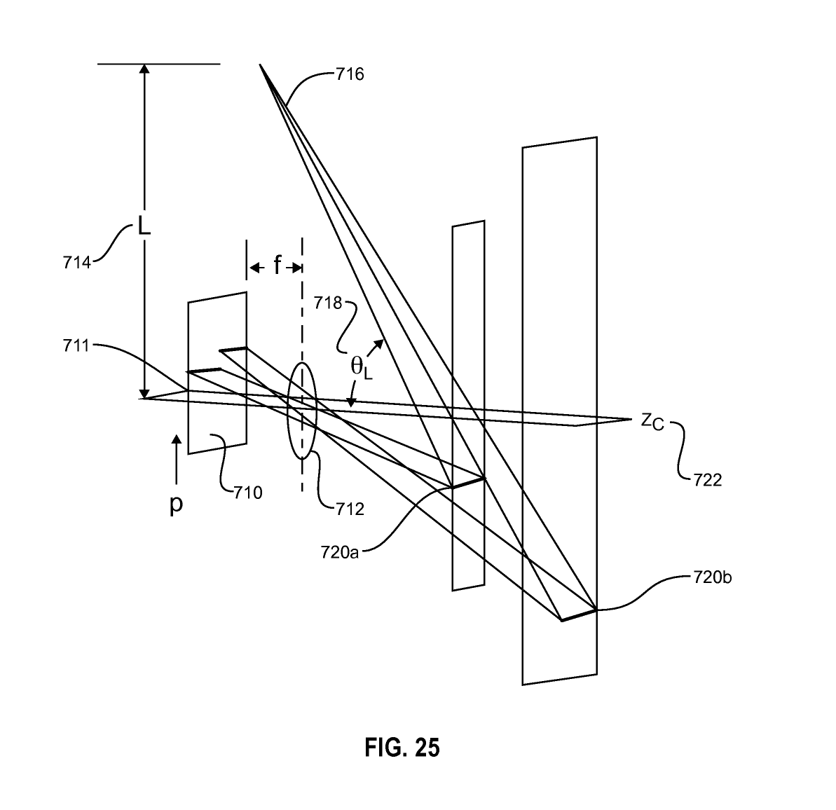

FIG. 23 describes one processing flow associated with this invention whereby the 3D information captured as described above is used to provide dimensions and other simple geometric properties of the 3D scene (such as area and angles) with minimal post-processing.

FIG. 25 illustrates the geometry for the laser range triangulation for a point of the projected laser pattern. The laser and the camera are mounted in a fixed arrangement with distance L 714 between the center of the camera's field of view 711 and the laser and an angle of θ_{L} 718 between the center axis z 722 of the camera field of view and the laser 716. Note that the laser beam 716 shown in this figure represents one point of the projected laser line, i.e., it is a cross-section view of the system and the projected laser line is perpendicular to the plane of the figure. For the laser-camera angle θ_{L} 718 shown in FIG. 25, as the laser is reflected from points more distant Z from the camera, the image of the laser spot moves up on the image sensor 710. The optics (camera lens system 712) reverses the image presented on the camera sensor array 710. For surfaces of four different distances from the camera, the reflection points are illustrated at 720a, 720b, 720c and 720d. Tracing the reflection lines back through the camera lens to the camera sensor illustrates how near points are low and far points are high on the camera sensor. The pixel position as a function of range is subject to the following formula:

$$p ( z ) = f \frac{L}{z} - f tan {θ}_{L}$$

The functional range of the triangulation function z_{range} 730 lies between the z values at which the reflected lines falls off of the camera sensor at the bottom zₘᵢₙ 732 and at the top zₘₐₓ 736. The range decreases with the increase of L and/or the increase of θ_{L} and depends on the desired choice for zₘₐₓ. The accuracy is proportional—it increases linearly with L and drops off as a function of 1/z²:

$$\vert \frac{d p}{d z} \vert = \frac{fL}{{z}^{2}}$$

Using this known accuracy dependency, the weighting of point data collected at higher accuracy geometry can be given greater weight than information gathered at lower accuracy geometries.

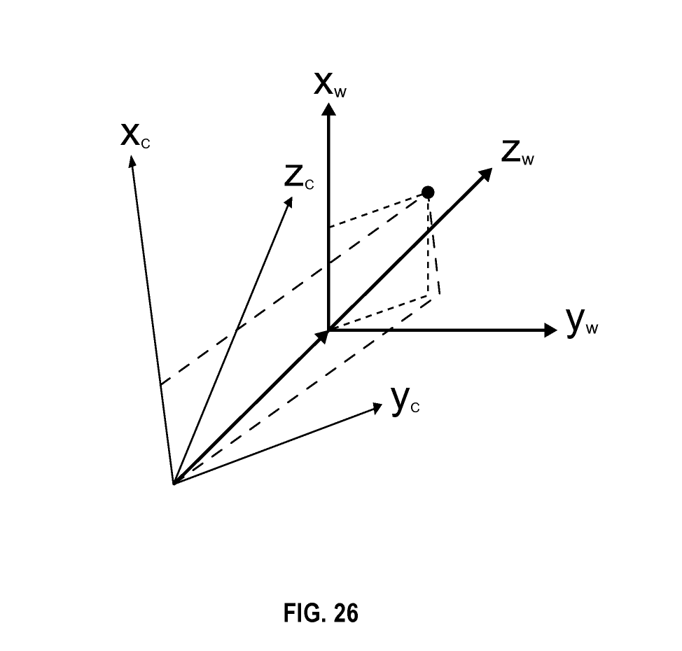

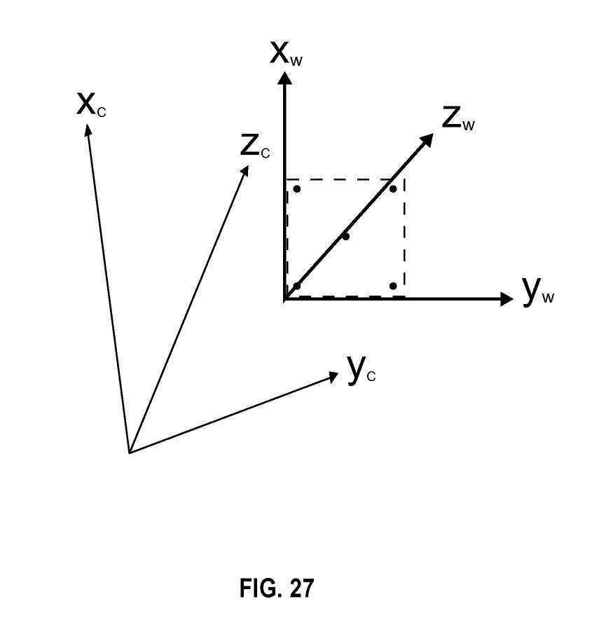

FIG. 26 shows more of a perspective view of the geometry of FIG. 25. It should be appreciated that each point along the laser pattern is treated individually. In the illustration there are two flat surfaces resulting in two line segments. For more complicated shapes and/or more complicated laser patterns, rather than segments there will be a more complicated curve where each point gives range to its respective reflecting point on the 3D object in the camera's coordinate frame.

In one embodiment, the point selection along the laser line is determined once the reference template fiducial markers and laser point positions are independently detected for a given frame n. The algorithm proceeds with 3D scene assembly for that frame. This first step involves computing the camera pose relative to a specific point on the reference template, typically the upper left fiducial marker. For this a general perspective n-point (PnP) algorithm configured for 4 world-image point correspondences is suitable. This subsequently provides the camera pose in the form of the rotation matrix (Rₙ) and translation vector (\vec{t}ₙ) in real world coordinates \vec{X}_{nW} (e.g. measured in feet, meters, etc). For the laser points, a standard fixed baseline triangulation calculation is used as described above. With the appropriate pre-calibration, this gives us the position of each laser pixel along the line in camera coordinates \vec{X}_{nC} (measured in feet, meters, etc). At this point we can proceed to calculate the 3D scene contributions for the frame using the following equation:

\vec{X}_{nW}=Rₙ⁻¹[\vec{X}_{nC}−\vec{t}ₙ]

As the scene is scanned with the laser and the world points are accumulated for successive frames, the complete set of world points \vec{X}_{nW} maps out a 3D point cloud representing the scanned scene. In principle there are no restrictions on camera orientation provided a reference template can be detected and registered in each frame. And, where more than one reference template is used, then there must be at least one frame in the video sequence showing each pair of adjacent reference templates.

FIG. 27 illustrates how the camera pose and position information is calculated from the image data. The camera coordinates change with each image as the camera is moved. The is illustrated by the camera coordinate axes x_{c}, z_{c} and y_{c}. The world coordinates axes are represented by x_{w}, z_{w} and y_{w}. The general matrix form of the world coordinate to camera coordinate transformation can be expressed as follows:

$$[ \begin{matrix}{x}_{C} \\ {y}_{C} \\ {z}_{C} \\ 1\end{matrix} ] = [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ] [ \begin{matrix}{x}_{W} \\ {y}_{W} \\ {z}_{W} \\ 1\end{matrix} ] = [ \begin{matrix}\overleftrightarrow{R} & {t}^{->} \\ {{0}^{->}}^{T} & 1\end{matrix} ] [ \begin{matrix}{{x}^{->}}_{W} \\ 1\end{matrix} ]$$

where w indicates world coordinates, c indicates camera coordinates, r_{nw} are the rotation coefficients represented by the submatrix \vec{R} that rotates the world coordinate frame to be parallel to the camera coordinate frame and where t is the translation coefficients that translate the origin of the world system to the camera system. The world coordinates never change, the camera coordinates change as the camera is moved. The reference template has at least four reference points for which the world coordinates are known. Once the transformation matrix is known, the points acquired in each image with local camera coordinates are transformed into global world coordinates using a simple matrix operation. In this way the 3D point cloud is successively built up as the points are added from different camera and laser pattern positions.

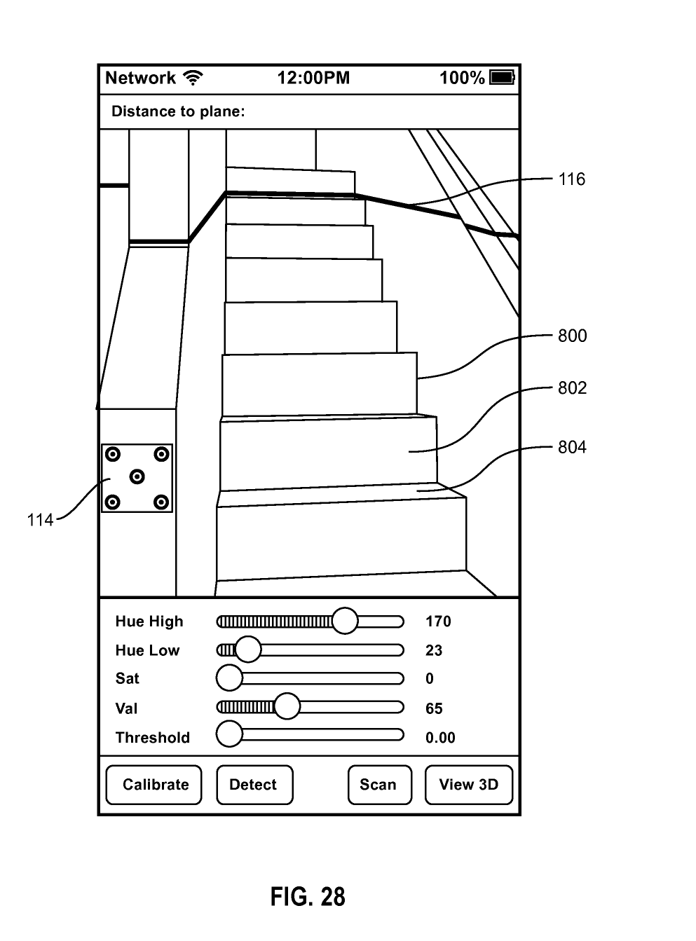

FIG. 28 illustrates how the matrix can be simplified when the reference template consists of fiducials that all lie in a single plane. With no loss of generality, the plane of the reference template can be chosen as the plane where z_{w}=0. Then the previous matrix representation becomes the following:

$$[ \begin{matrix}{x}_{C} \\ {y}_{C} \\ {z}_{C} \\ 1\end{matrix} ] = [ \begin{matrix}{r}_{11} & {r}_{12} & arb & {t}_{x} \\ {r}_{21} & {r}_{22} & arb & {t}_{y} \\ {r}_{31} & {r}_{32} & arb & {t}_{z} \\ 0 & 0 & 0 & 1\end{matrix} ] [ \begin{matrix}{x}_{W} \\ {y}_{W} \\ 0 \\ 1\end{matrix} ]$$

where arb indicates any arbitrary number can be used in the matrix because it will be multiplied by zero in the matrix equation and therefore has no effect on the result. In terms of the degrees of freedom in the transformation, there are now only 9 degrees of freedom (“DOF”) rather than 12. Furthermore, since the relative scale of the two coordinate sets is arbitrary, all coefficients can be multiplied by any non-zero constant without affecting the transformation. As a result, the DOF can effectively be reduced to 8 for fully characterizing the pose of the camera for transformational purposes. A reference template with 4 or more coplanar points provides the necessary 8 DOF using the 4 point locations captured in the camera image together with a priori knowledge of the reference points in world coordinates.

Accuracy of the pose vector may be improved by including additional fiducial markers in the template (>4). In this way, the additional fiducials may be used to test the alignment accuracy and trigger a 2nd tier re-calibration if necessary. Another embodiment uses the additional fiducials to drive an over-fit Homography based on least squares, least median, random sample consensus,etc. algorithms. Such an approach would minimize error due to one/several poorly detected fiducial markers while broadening the usable range and detection angle and thus increasing robustness.

Finally, FIG. 29 illustrates another application for the 3D surface modeling. A reference template 114 is placed on the railing of a staircase 800. The camera films while the user scans the scene with the laser pattern 116 up and down the staircase 800 over its risers 802 and treads 116. From the point cloud model, the user is able to identify the key parts of the stairs and calculate the area of the risers and treads for the purpose of purchasing material such as tile or carpeting for covering the stairs.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

1. A 3D mapping device comprising
a range pattern projector which projects a ranging pattern attached to or incorporated with;
a camera which captures a sequence of images from a sequence of positions and poses relative to the object or scene to be 3D mapped;
a pose/position measuring engine for determining the pose and position of the camera for each of said sequence of images where a reference template is located somewhere in each of said images;
a triangulation engine for determining the distance of individual points on the object or in a scene to be mapped on which the pattern projector's pattern is projected;
a mapping engine which provides a dimensionally correct 3D map output of the object or scene based on the input of the pose/positioning engine output and the triangulation engine output for the sequence of images.

2. The 3D mapping device of claim 1 wherein the ranging pattern is a line or a pair of crossing lines.

3. The 3D mapping device of claim 1 wherein the origin of the projected pattern is offset by a distance from a central axis of the camera and the projector has a central axis which is non parallel to the central axis of the camera.

4. The 3D mapping device of claim 1 wherein the range pattern projector is a laser with a DOE mask.

5. The 3D mapping device of claim 1 further comprising of mapping known distances of objects with the rows and or columns of pixels on a digital camera scanner where the reflected projected pattern appear.

6. The 3D mapping device of claim 1 wherein the reference template is a physical object with at least four coplanar reference points detectable in a digital image.

7. The 3D mapping device of claim 1 wherein the reference template is a physical object with at least four coplanar reference points which emit light of a frequency or intensity that makes the points more detectable by the image scanner.

8. The 3D mapping device of claim 1 wherein the reference template is projected by a reference template projector.

9. The 3D mapping device of claim 1 wherein a series of reference templates are placed proximate to the object or in the scene to be 3D mapped.

10. The 3D mapping device of claim 1 further comprising of an engine for extracting real world dimensions from the 3D mapping based on user input of which dimensions are desired.
